(19) United States
(12) Patent Application Publication
(10) Pub. No.: US 2015/0043192 A1
(43) Pub. Date: Feb. 12, 2015

(54) SWITCH AND KEYBOARD PROVIDED THEREWITH

(71) Applicant: OMRON Corporation, Kyoto-Shi (JP)

(72) Inventors: Yasuhiro Tanoue, Otsu-shi (JP); Mamiko Naka, Okayama-shi (JP); Kazuhira Izawa, Okayama-shi (JP); Masayuki SHINOHARA, Nagaokakyou-city (JP)

(73) Assignee: OMRON Corporation, Kyoto-Shi (JP)

(21) Appl. No.: 14/333,816

(22) Filed: Jul. 17, 2014

(30) Foreign Application Priority Data
Aug. 9, 2013 (JP) 2013-166876

(51) Int. Cl. H01H 13/83

(52) U.S. Cl. CPC H01H 13/83
USPC 362/23.03

(57) ABSTRACT

There is provided a switch having a wide, uniform luminance region. In the switch, light emitted from a light source is output through an outgoing surface located in an upper end surface of a light guide, the light being incident from an incident surface located in a lower end surface of the light guide arranged above the light source. A concave lens is formed in the incident surface of the light guide, and a microlens array is formed in the outgoing surface of the light guide.

### CROSS-REFERENCE TO RELATED APPLICATION(S)

This application claims the benefit of priority from Japanese Patent Application No. 2013-166876, filed 9 Aug. 2013, the entire contents of which is incorporated herein by reference for all purposes.

### BACKGROUND

The present invention relates to a switch, particularly to a lighted keyboard switch including a light source surface-mounted on a board.

A conventional lighted switch is described, for example, in Japanese Unexamined Patent Publication No. 2006-302555 which discloses a rubber switch, in which a light guide transmitting light is arranged immediately above a LED surface-mounted on a board, as a lighted switch.

Japanese Unexamined Patent Publication No. 2009-123662 discloses a switch device in which a colorless and transparent lens is arranged above a LED surface-mounted on the board. A lower surface of lens is formed into a concave surface while an upper surface of lens is formed into a convex surface by embossing, for preventing luminance unevenness.

However, in the rubber switch of Japanese Unexamined Patent Publication No. 2006-302555, as illustrated in FIG. 4 of the document, an upper end surface and a lower end surface of light guide are flat surfaces. For this reason, the light incident from the LED through the lower end surface of light guide is output from the upper end surface while directivity and emission distribution of the light are not improved. As a result, variation in luminance is generated in the light transmitted through light guide, and does not result in a switch having good luminance uniformity.

In the switch device of Japanese Unexamined Patent Publication No. 2009-123662, a region having the good luminance uniformity is narrowed in the case that a sectional area of lens is restricted due to a relationship with an area occupied by a contact mechanism or the like.

### SUMMARY

In accordance with an embodiment, there is a switch comprising:

a light guide, wherein light emitted from a light source is output through an outgoing surface located in an upper end surface of the light guide, the light being incident from an incident surface located in a lower end surface of the light guide arranged above the light source, and

a concave lens is formed in the incident surface of the light guide, and a microlens array structure is formed into the outgoing surface of the light guide.

### BRIEF DESCRIPTION OF THE DRAWINGS

FIGS. 1A and 1B are overall perspective views illustrating a switch according to an embodiment when the switch is viewed from different angles;

FIG. 2 is an exploded perspective view of the switch in FIG. 1A;

FIG. 3 is an exploded perspective view of the switch in FIG. 1B;

FIGS. 4A and 4B are enlarged perspective views illustrating a box-form base in FIGS. 2 and 3 when the box-form base is viewed from different angles;

FIG. 5 is an enlarged perspective view illustrating the box-form base in FIGS. 4A and 4B when the box-form base is viewed from a different angle;

FIGS. 6A and 6B are enlarged perspective views illustrating a contact terminal in FIGS. 2 and 3 when the contact terminal is viewed from different angles;

FIGS. 7A, 7B, and 7C show enlarged perspective views illustrating a light guide in FIGS. 2 and 3 when the light guide is viewed from different angles and a sectional view of the light guide;

FIGS. 8A and 8B are enlarged perspective views illustrating a push button in FIGS. 2 and 3 when the push button is viewed from different angles;

FIGS. 9A and 9B are a longitudinal sectional perspective view and a transverse sectional view illustrating the switch in FIGS. 1A and 1B before operation;

FIGS. 10A and 10B are a longitudinal sectional perspective view and a transverse sectional view illustrating the switch in FIGS. 1A and 1B after operation;

FIGS. 11A and 11B are longitudinal sectional perspective views illustrating a switch according to an embodiment before and after operation;

FIGS. 12A and 12B are enlarged perspective views illustrating a push button of the switch in FIGS. 11A and 11B when the push button is viewed from different angles;

FIGS. 13A and 13B are enlarged perspective views illustrating a frame-shaped cover of the switch in FIGS. 11A and 11B when the frame-shaped cover is viewed from different angles;

FIG. 14 is a schematic view illustrating an analysis condition for a switch according to Example 1;

FIG. 15 is a graph illustrating an analysis result of the switch in Example 1;

FIGS. 16A and 16B are distribution diagrams illustrating analysis results according to Examples 2 and 3;

FIGS. 17A and 17B are distribution diagrams illustrating analysis results in Comparative examples 1 and 2;

FIG. 18 is a sectional perspective view illustrating an analysis condition for the switch according to Example 4;

FIG. 19 shows distribution diagrams illustrating an analysis result in Example 4;

FIG. 20 shows other distribution diagrams illustrating an analysis result in Example 4; and

FIG. 21 shows still other distribution diagrams illustrating an analysis result in Example 4.

### DETAILED DESCRIPTION

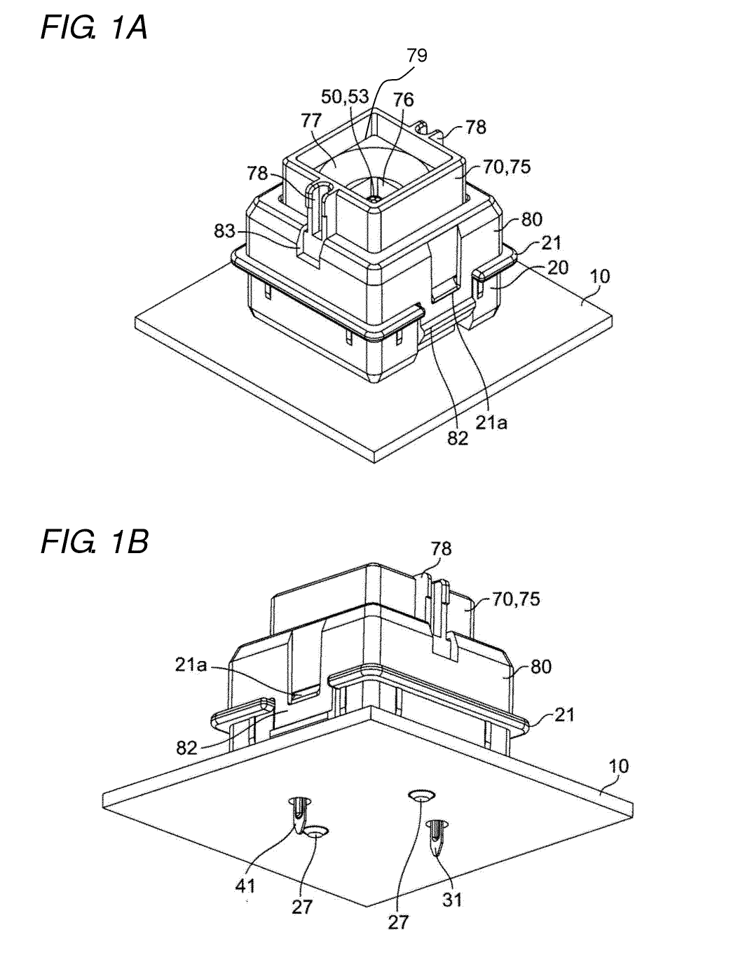

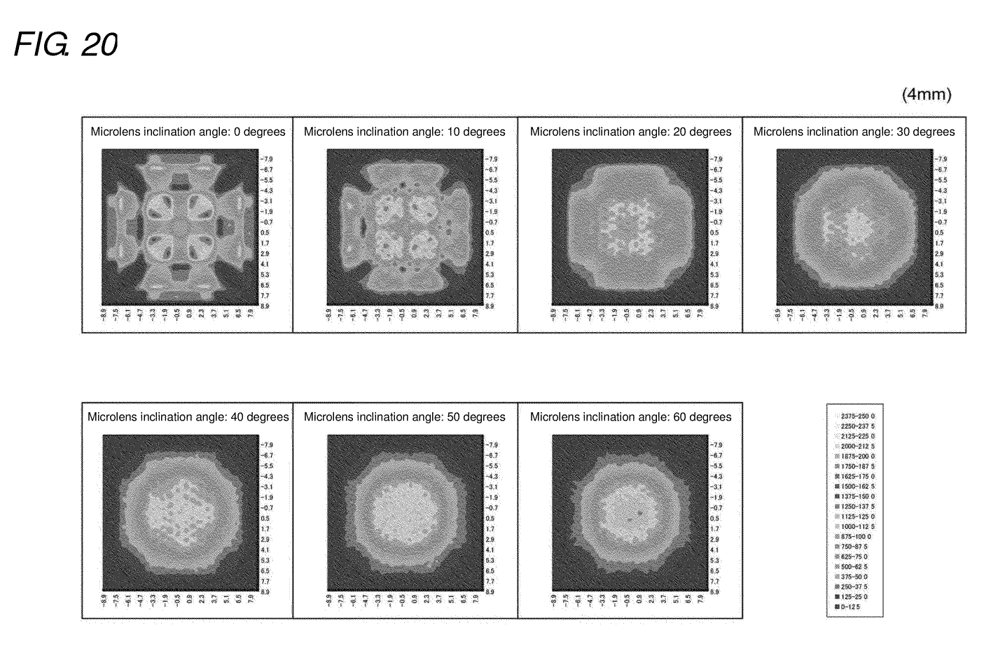

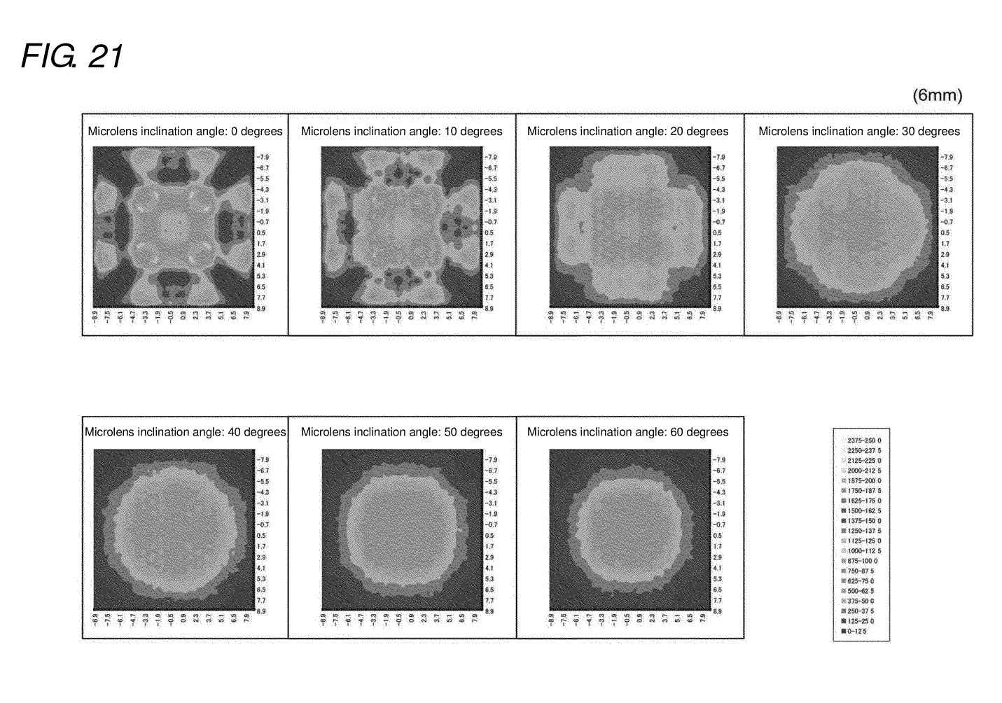

Hereinafter, a switch according to an embodiment will be described with reference to FIGS. 1A to 21.

As illustrated in FIGS. 1A to 10B, a switch according to an embodiment includes a box-form base 20 installed in a board 10 on which a light source 11 such as an LED is surface-mounted or directly mounted, a pair of contact terminals 30 and 40 assembled in box-form base 20, a light guide 50, a return spring 60, a push button 70, and a frame-shaped cover 80.

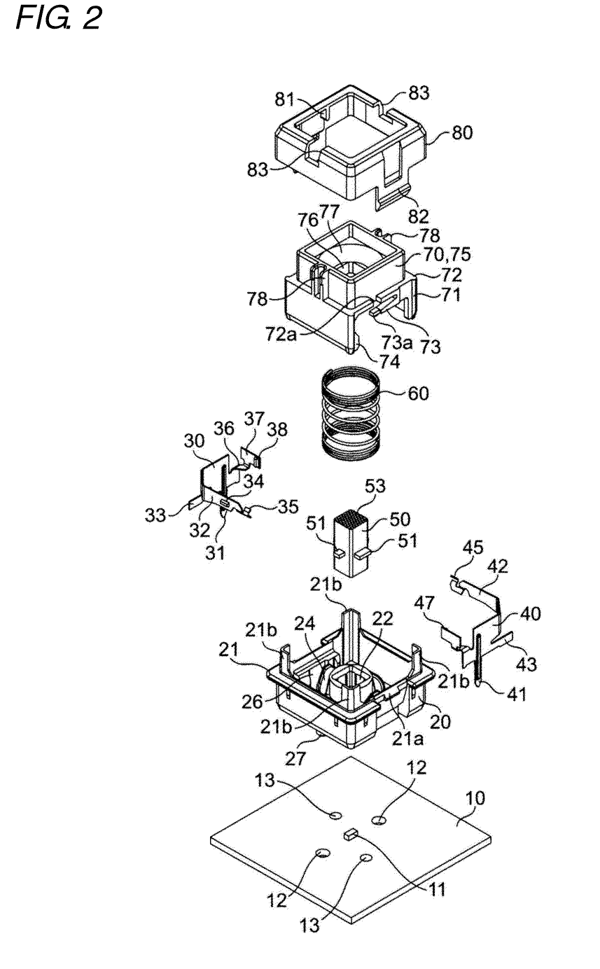

In the board 10, as illustrated in FIG. 2, a pair of aligning holes 12 is made while a surface-mounted light source 11 is located therebetween, and a pair of terminal holes 13 and 13 is made while the light source 11 is located therebetween.

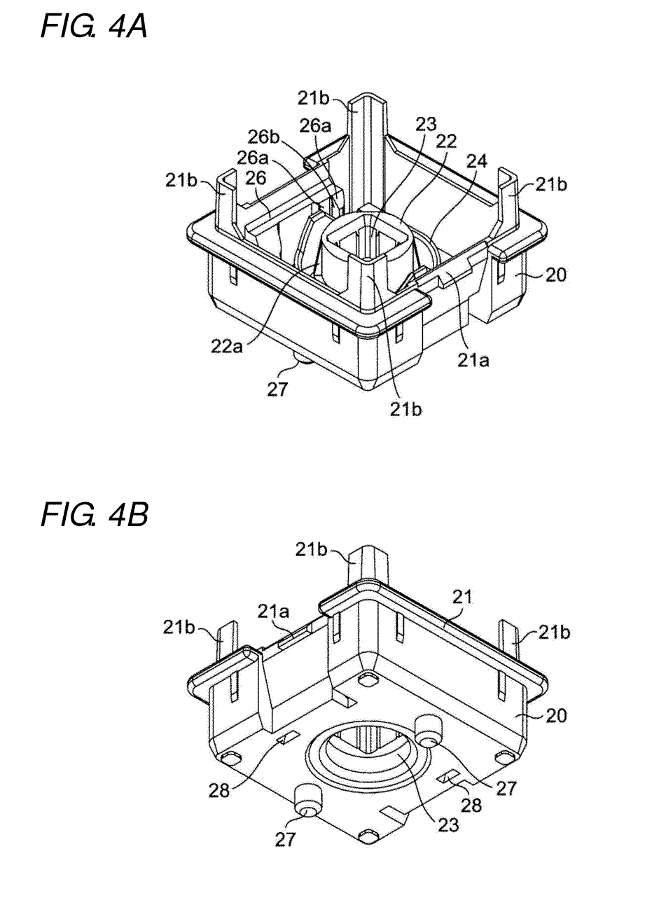

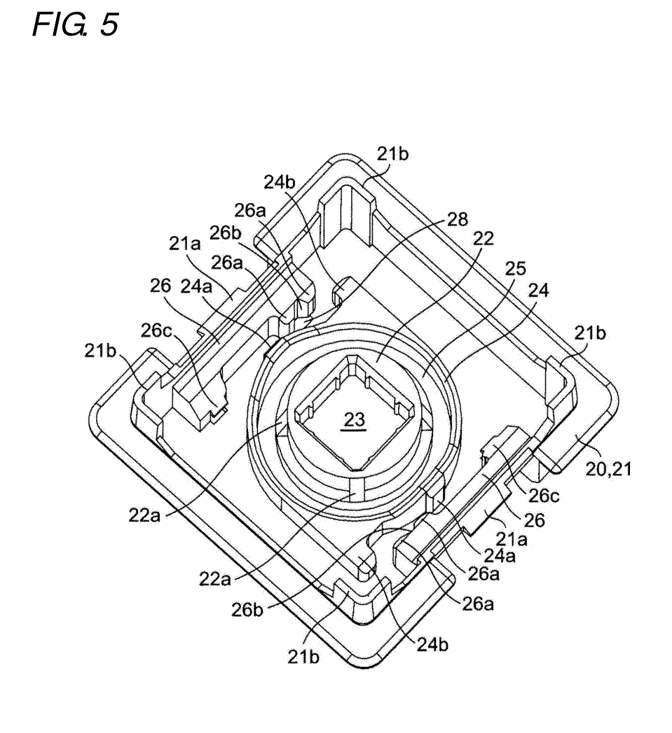

As illustrated in FIGS. 4A, 4B and 5, a box-form base 20 is a resin molded article having a square shape in planar view. An annular rib 21 is formed along an opening edge of the box-form base 20, and sides opposed to each other in an annular rib 21 are notched to form engaging receiving parts 21a. Guide projections 21b, each having a substantial L-shape in section, are provided at corners of the opening edge of the box-form base 20. An insertion hole 23 having a square shape in planar view is made in the support base 22 projected from a center of a bottom surface of the box-form base 20. Reinforcing ribs 22a, each including a tapered surface, are molded while being integral with an outer peripheral surface of the support base 22.

In the box-form base 20, as illustrated in FIG. 5, a circular annular rib 24 is concentrically projected around the support base 22 to form an annular groove 25. A pair of press-fitting projections 24a and 24b is laterally projected from an outer peripheral surface of the circular annular rib 24 while press-fitting projections 24a and 24b are parallel to each other. In the box-form base 20, an abutting step 26 is projected from an inside surface opposed to press-fitting projections 24a and 24b, a pair of press-fitting projections 26a is provided in an edge portion on one of sides in the inside surface of the abutting step 26 to form a guide groove 26b, and a retaining projection 26c is provided in an edge portion on the other side. As illustrated in FIG. 4B, a pair of aligning projections 27 is provided in a lower surface of the box-form base 20 while an insertion hole 23 is made therebetween, and a pair of terminal holes 28 is also made. The terminal hole 28 communicates with the guide groove 26b.

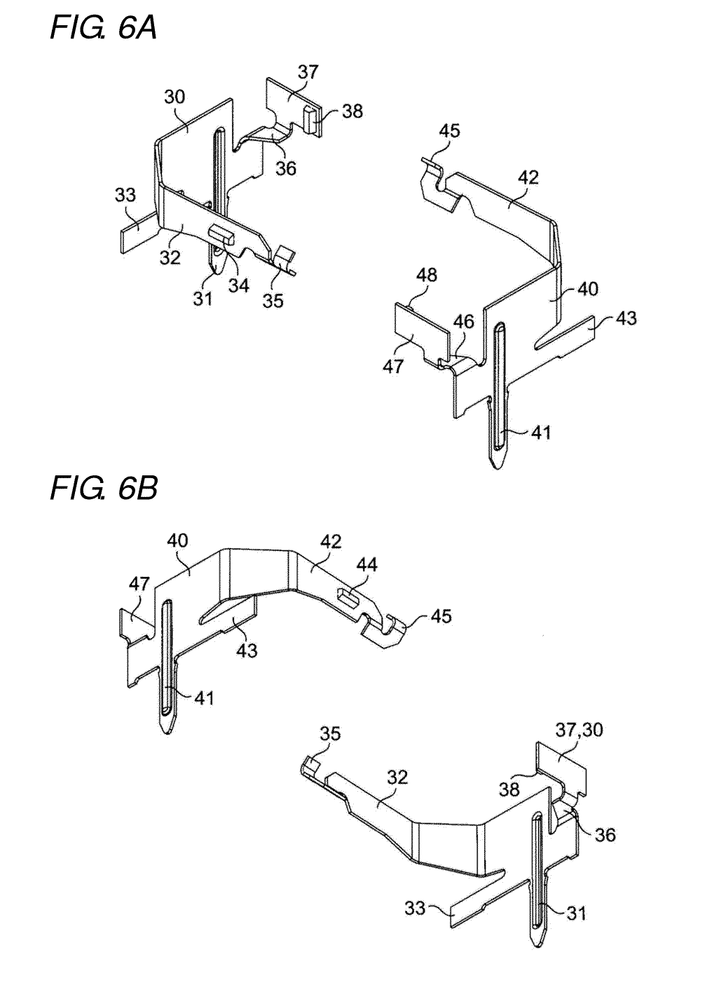

As illustrated in FIGS. 6A and 6B, the pair of contact terminals 30 and 40 are identical in shape, and are symmetrically arranged in the box-form base 20 with respect to a point.

A conductive sheet is punched and pressed to form the contact terminal 30, and the contact terminal 30 is processed to have a protrusion to form a terminal part 31. A resilient movable touch piece 32 and a retaining tongue piece 33 are extended from the edge portion on one of the sides of the terminal part 31. A movable contact 34 is provided in an outward surface in a free end of the movable touch piece 32, and a pressing receiving part 35 is laterally extended from the free end.

An aligning part 36 having a substantially L-shape is extended from the edge portion on the other side of the terminal part 31, and a fixed touch piece 37 is extended from an aligning part 36. A fixed contact 38 is provided in the edge portion of the inside surface of the fixed touch piece 37.

As the contact terminal 40 has the same shape as the contact terminal 30, each part of the contact terminal 40 is designated by the numeral corresponding to the contact terminal 30, and will not be described.

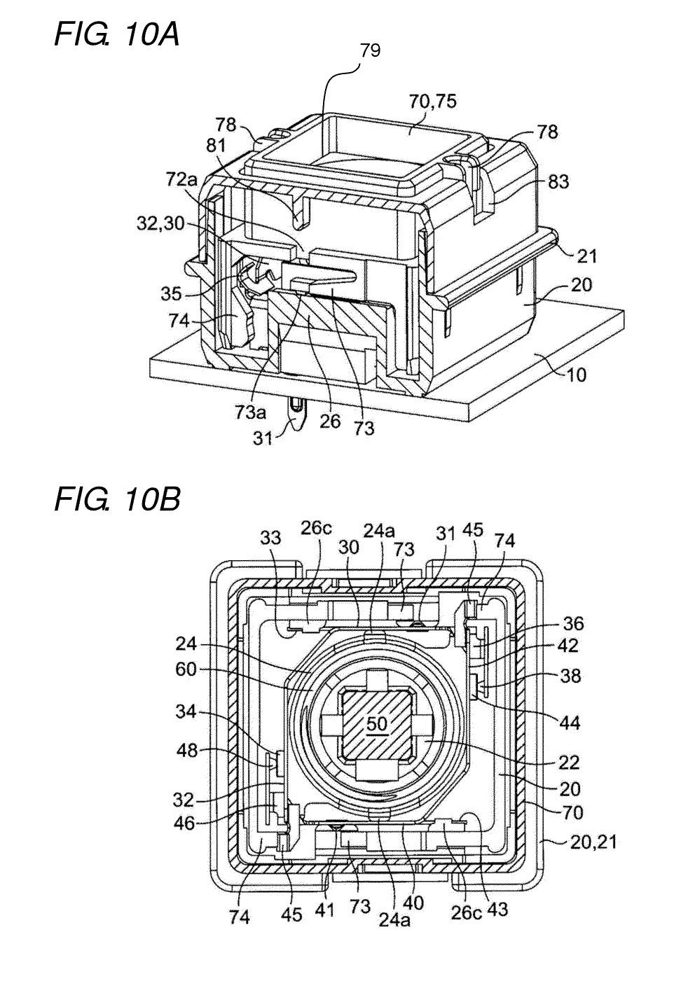

When terminal parts 31 and 41 of contact terminals 30 and 40 are inserted in terminal holes 28 along guide grooves 26b of the box-form base 20, both sides of terminal parts 31 and 41 are press-fitted between press-fitting projections 26a and 26a and press-fitting projections 24a and 24b of the box-form base 20, thereby aligning contact terminals 30 and 40 in a plate thickness direction. When contact terminals 30 and 40 are further press-fitted, aligning parts 36 and 46 of contact terminals 30 and 40 abut press-fitting projections 24b and 24b of the box-form base 20, thereby aligning contact terminals 30 and 40 in a vertical direction. Retaining tongue pieces 33 and 43 of contact terminals 30 and 40 are latched and retained in retaining projections 26c and 26c of the box-form base 20, respectively. Therefore, movable contacts 34 and 44 come into press contact with fixed contacts 48 and 38, respectively (see FIG. 10B).

As contact terminals 30 and 40 have the same shape, advantageously production cost can be reduced while using common components.

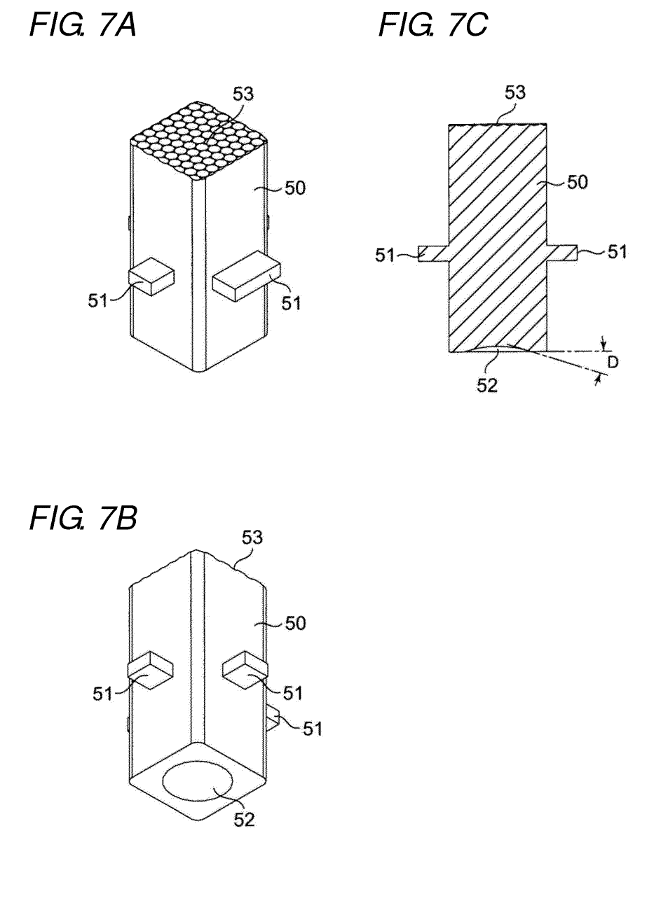

As illustrated in FIGS. 7A to 7C, the light guide 50 having a square prism shape is made of a translucent resin (such as a polycarbonate resin and an acrylic resin). An aligning projection 51 is provided on an outside surface of the light guide 50, a concave lens 52 is formed in an incident surface that is located in a lower end surface of the light guide 50, and a microlens array 53 or a microlens array structure 53 is formed in an outgoing surface that is located in an upper end surface of the light guide 50.

In an embodiment, the luminance of the light emitted from the light source 11 is divided into two peaks by the concave lens 52 formed in the incident surface, which ensures a wide luminance distribution. Additionally, the directivity of the light emitted from the light source 11 is moderated by the microlens array 53 of the outgoing surface to ensure that a region illuminated by the light source 11 has good luminance uniformity. Accordingly, the switch has a wide uniform luminance region based on the uniform luminance of the light output from the light guide. The light guide 50 is not limited to the square prism shape. The light guide 50 may have a columnar shape, a polygonal prism shape such as a triangular prism shape, a truncated cone shape, or a polygonal truncated pyramid shape. Accordingly, a useful switch may be obtained as the shape of the light guide can be selected from a variety of shapes as described in the above according to design requirements.

Referring to FIG. 7C, the concave lens 52 of the incident surface is inclined at an inclination angle D relative to the incident surface. Preferably the inclination angle D of the concave lens 52 is less than or equal to 55 degrees, more preferably is less than or equal to 50 degrees. When the inclination angle is less than or equal to 55 degrees, a balance between the luminance uniformity and luminance efficiency may be achieved.

Preferably each of the microlenses in the microlens array 53 formed in the outgoing surface has a diameter of 1 mm or smaller. This is because the luminance uniformity is improved when the diameter is equal to or smaller than 1 mm.

Each of the microlenses in the microlens array 53 is inclined at a microlens inclination angle relative to the outgoing surface. Preferably the microlens inclination angle ranges from 20 degrees to 60 degrees. Accordingly, the switch having the small variation in luminance and the good luminance uniformity is obtained when the inclination angle is greater than or equal to 20 degrees. When the microlens inclination angle ranges from 20 degrees to 60 degrees, the light is sufficiently mixed and the desired luminance uniformity may be ensured.

Additionally, when the inclination angle is less than 60 degrees, the switch in which a metallic mold for the light guide is easily produced is obtained.
Specifically, when the microlens inclination angle is less than 60 degrees, an angle formed between the microlenses adjacent to each other is not excessively decreased and facilitates in the production of the metallic mold for making the microlenses.

Preferably the microlenses are uniformly arranged. More preferably the microlenses are arranged adjacent to each other such that a flat gap is not generated. With regard to a possible microlens arranging method, for example, the microlenses may be arranged into a lattice shape. Alternatively, the microlenses may be arranged into a honeycomb structure in which six microlenses are located around one microlens. Further, the microlenses are arranged adjacent to each other, and to partially overlap each other. Accordingly, the switch has a variety of options depending on the application, and the degree of freedom in design may be enhanced to facilitate designing of the switch.

The light guide 50 is inserted in the insertion hole 23 of the support base 22 provided in the box-form base 20, and the aligning projection 51 of the light guide 50 is latched in the upper end surface of the support base 22, thereby aligning the light guide 50.

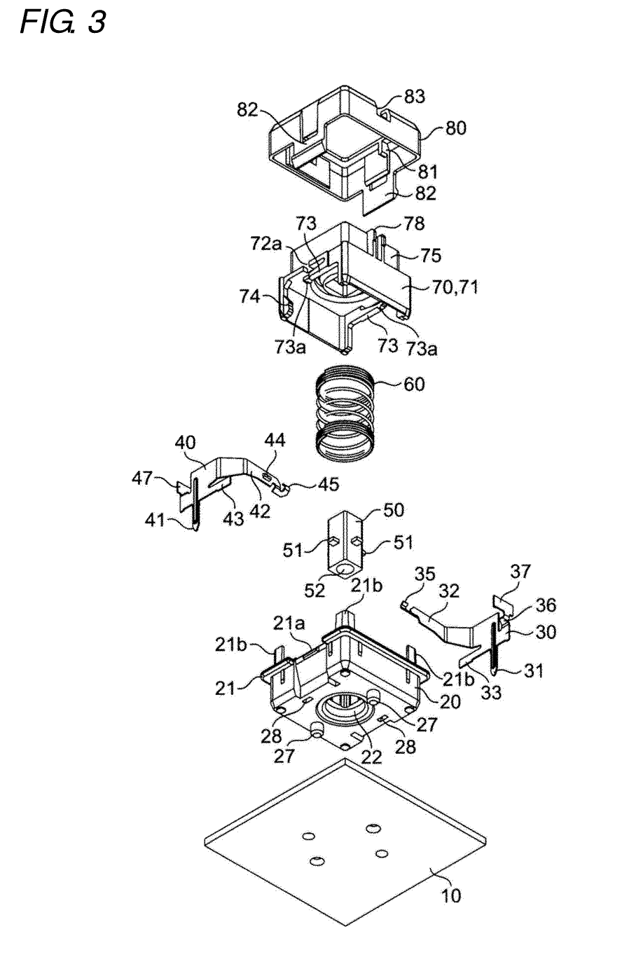

As illustrated in FIGS. 2 and 3, the return spring 60 is a coil spring, and the return spring 60 is aligned in the annular groove 25 of the box-form base 20 to upwardly bias the push button 70.

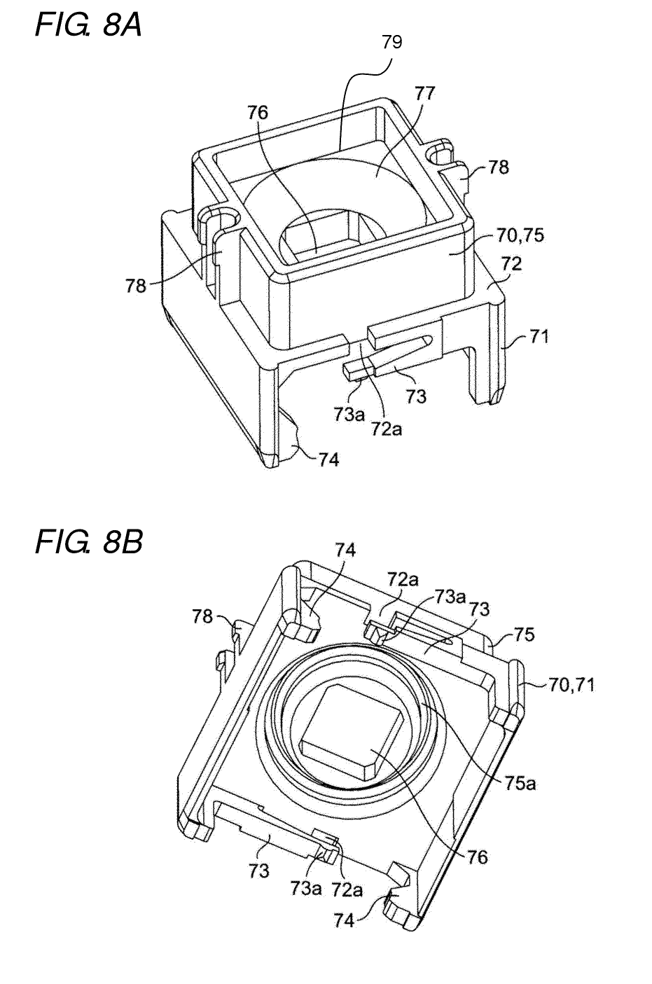

As illustrated in FIGS. 8A and 8B, a sliding part 71 and a frame-shape button body 75 are provided in the push button 70. The sliding part 71 has a planar shape slidably fitted through an opening of the box-form base 20. The button body 75 has a planar shape in which an annular step 72 can be formed in an upper surface of the sliding part 71.

The sliding part 71 has external dimensions adapted to be slidable along the opening of the box-form base 20, and a cantilever-shape elastic touch piece 73 and a pressing rib 74 are projected from an inward surface of the sliding part 71 in each of edge portions opposed to each other. In the sliding part 71, an abutting projection 73a is provided in the free end of the elastic touch piece 73, and a notch 72a is formed in the annular step 72 located above the elastic touch piece 73.

On the other hand, in the button body 75, a square fitting hole 76 is made in the center of a bottom surface, and a mortar-shaped tapered surface 77 is formed at an opening edge 79 of the push button 70. In the button body 75, a pair of engaging ribs 78 is vertically arrayed in each of the outside surfaces opposed to each other in order to engage a cap (not illustrated) in which a character or the like is printed, and a circular annular groove 75a is provided in the center of a lower surface of the push button 70 (see FIG. 8B).

The sliding part 71, provided in the push button 70, may be adapted to be fitted in the opening of the box-form base 20, whereby the light guide 50 is fitted in the square fitting hole 76 and an upper end of the return spring 60 is fitted in the circular annular groove 75a. The pressing ribs 74 of the push button 70 may be adapted to press pressing receiving parts 35 and 45 of contact terminals 30 and 40 to elastically deform movable touch pieces 32 and 42 such that the movable contacts 34 and 44 separate from the fixed contacts 48 and 38.

As illustrated in FIGS. 2 and 3, a frame-shaped cover 80 has a planar shape adapted for placing the frame-shaped cover 80 on the annular rib 21 of the box-form base 20. The frame-shaped cover 80 has a sectional shape adapted for latching and retaining the frame-shaped cover 80 in the annular step 72 of the push button 70. Position restriction ribs 81 are projected from the opening edges opposed to each other in the inside surface of the frame-shaped cover 80. In the frame-shaped cover 80, elastic engaging parts 82 are projected from one of pairs of outside surfaces opposed to each other, and fitting notches 83 are provided in the other pair of outside surfaces opposed to each other.

An engaging rib 78 of the push button 70 is slidably fitted in the fitting notch 83 by fitting the frame-shaped cover 80 in the box-form base 20, and the push button 70 is retained by elastically engaging the elastic engaging part 82 in the engaging receiving part 21a of the box-form base 20.

Operation of the switch including the above components will be described below.

In an embodiment, the contact terminal 30 is mainly described because contact terminals 30 and 40 are symmetrically arranged with respect to a point and the contact terminal 40 has the same shape as the contact terminal 30.

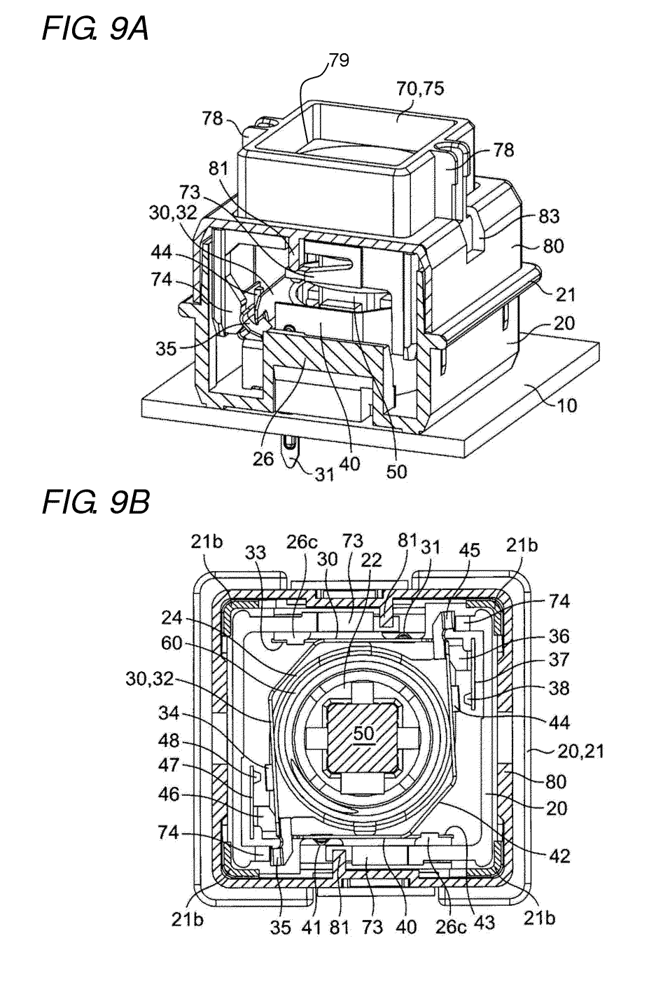

As illustrated in FIGS. 9A and 9B, in the case that the push button 70 is not pressed, the elastic touch piece 73 of the push button 70 abuts on the position restriction rib 81 of the frame-shaped cover 80. On the other hand, because the pressing rib 74 of the push button 70 presses pressing receiving part 35 of the contact terminal 30, the movable touch piece 32 is elastically deformed, and the movable contact 34 separates from the fixed contact 48 of contact terminal 40.

As illustrated in FIGS. 10A and 10B, when the push button 70 is pushed down against a spring force of the return spring 60, the pressing rib 74 disengages from pressing the receiving part 35 of the movable touch piece 32. Therefore, the movable touch piece 32 returns elastically, the movable contact 34 comes into contact with the fixed contact 48 of the contact terminal 40, and the pair of contact terminals 30 and 40 are electrically connected to each other to output an operation signal. As a result, the light source 11 is lit through a control circuit (not illustrated), the light is output from the concave lens 52 in the incident surface of the light guide 50 through the microlens array 53 in the outgoing surface, and passes through a lighting surface of a keytop (not illustrated). At this point, the abutting projection 73a of the elastic touch piece 73 of the push button 70 abuts on the upper end surface of the abutting step 26 of the box-form base 20. However, because of the elastic deformation of the elastic touch piece 73 and a small contact area of the abutting projection 73a, a large impact noise is not generated but a silent type switch is obtained.

When the pressing of the push button 70 is released, the push button 70 is pushed up by the spring force of the return spring 60, the pressing rib 74 presses the pressing receiving part 35 of the movable touch piece 32 again, and the movable contact 34 separates from the fixed contact 48. When the push button 70 returns to an original position, the elastic touch piece 73 is elastically deformed to restrain the generation of the impact noise even when the elastic touch piece 73 of the push button 70 abuts on the position restriction rib 81 of the frame-shaped cover 80. Particularly, when the elastic touch piece 73 abuts on the position restriction rib 81, the position restriction rib 81 is fitted in the notch 72a of the push button 70 to separate an inner space and an outer space of the push button 70 from each other. Therefore, according to an embodiment, the silent type switch having small operation sound and return sound is obtained.

In the case that the light source 11 is turned off, similarly to the above operation, the push button 70 may be pressed to output the operation signal, and the light source 11 is turned off through the control circuit (not illustrated).

In an embodiment, the light source 11 is lit and turned off by operating push button 70. Alternatively, for example, the light source 11 may always be lit or blinked through a control circuit (not illustrated) and is independent of the operation of the push button 70.

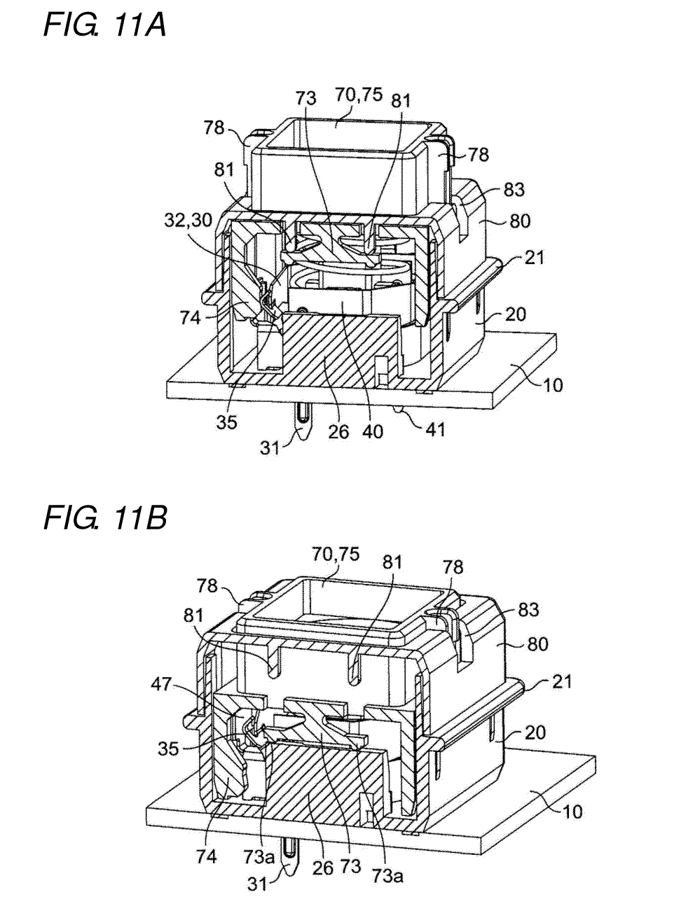

FIGS. 11A to 13B illustrate an embodiment having a basic configuration which is substantially similar to the embodiment illustrated in FIGS. 1A to 10B, and differs in shapes of the push button 70 and the frame-shaped cover 80.

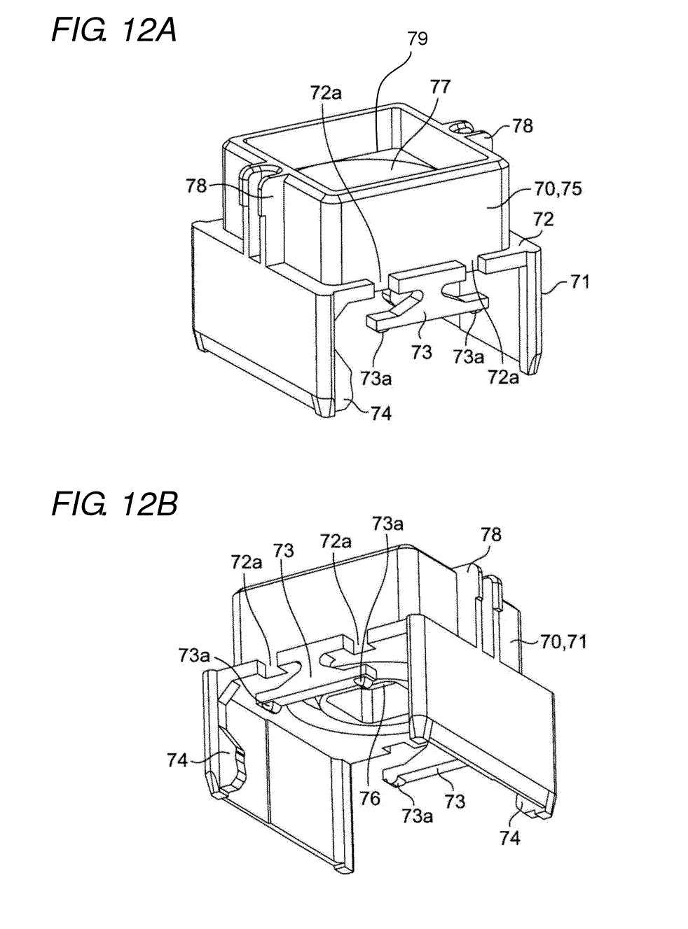

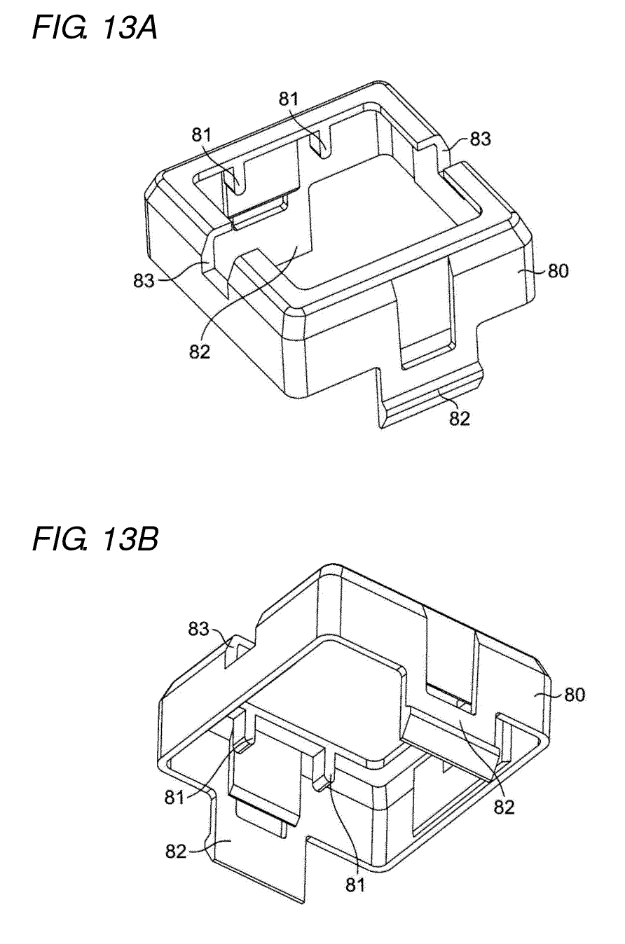

As illustrated in FIGS. 12A and 12B, the push button 70 is substantially similar to the push button 70 in FIGS. 8A and 8B, and differs in that the elastic touch piece 73 is formed into a substantial T-shape. As illustrated in FIGS. 13A and 13B, the frame-shaped cover 80 is substantially similar to the frame-shaped cover 80 of FIG. 2 and differs in that a pair of position restriction ribs 81 is provided. Since other configurations in the embodiments described are similar, the same components will be designated by the same numerals, and will not be described.

In the push button 70, the operations performed by the pressing and the release and the return operations are substantially similar to those of the embodiment illustrated in FIGS. 1A to 10B. The operation of push button 70 differs from the embodiment illustrated in FIGS. 1A to 10B in that, during the operation and the return of the push button 70, both ends of the elastic touch piece 73 abut the upper end surface of the abutting step 26 of the box-form base 20 and the pair of position restriction ribs 81 of the frame-shaped cover 80, respectively. Therefore, impact energy is dispersed to four points, and the impact noise is decreased compared with the embodiment in for example, FIG. 1A and FIG. 1B. Advantageously, the more silent type switch can be obtained.

### EXAMPLE 1

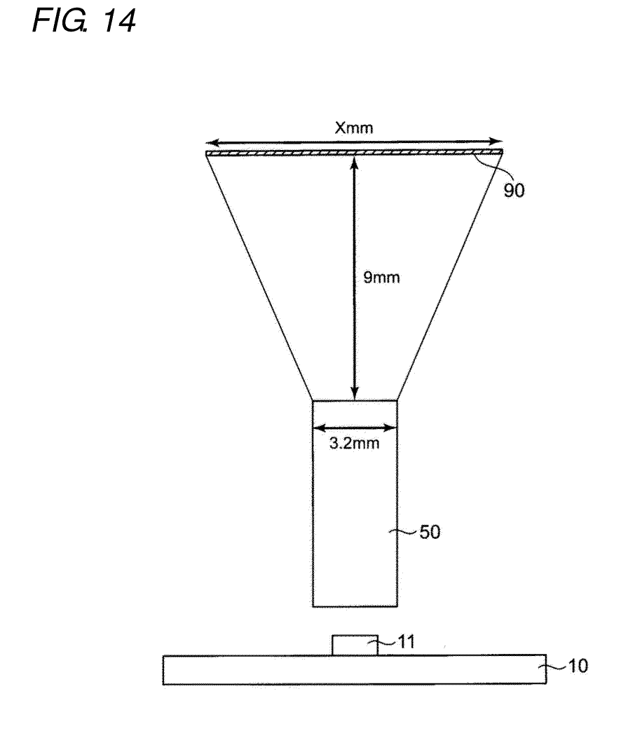

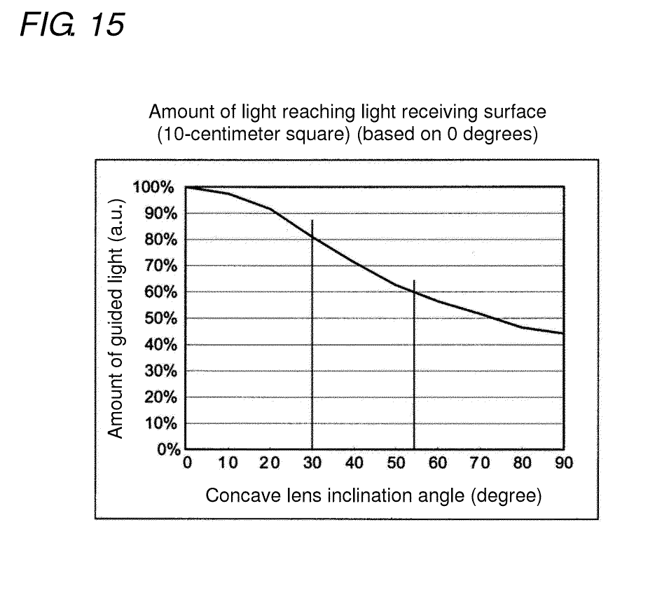

As illustrated in FIG. 14, a columnar light guide 50 having a diameter of 3.2 mm and a length of 7.5 mm was arranged directly above the light source 11 while separating from the light source 11 by a distance of 0.2 mm, and a correlation between the amount of light reaching a keytop light-receiving surface 90 and the inclination angle of the concave lens 52 was analyzed. The keytop light-receiving surface 90 had a side of 10 cm and was separated from the outgoing surface of the light guide 50 by 9 mm. The microlens array structure is formed into the outgoing surface. In the microlens array structure, the microlenses each having a diameter of 0.4 mm and an inclination angle of 30 degrees were arranged into the honeycomb structure. FIG. 15 illustrates a graph of an analysis result.

As is clear from FIG. 15, the inclination angle of the concave lens 52 has to be less than or equal to 55 degrees in order to exceed a desired luminance efficiency of 60%, and the inclination angle has to be less than or equal to 30 degrees in order to exceed a more desired luminance efficiency of 80%.

### EXAMPLE 2

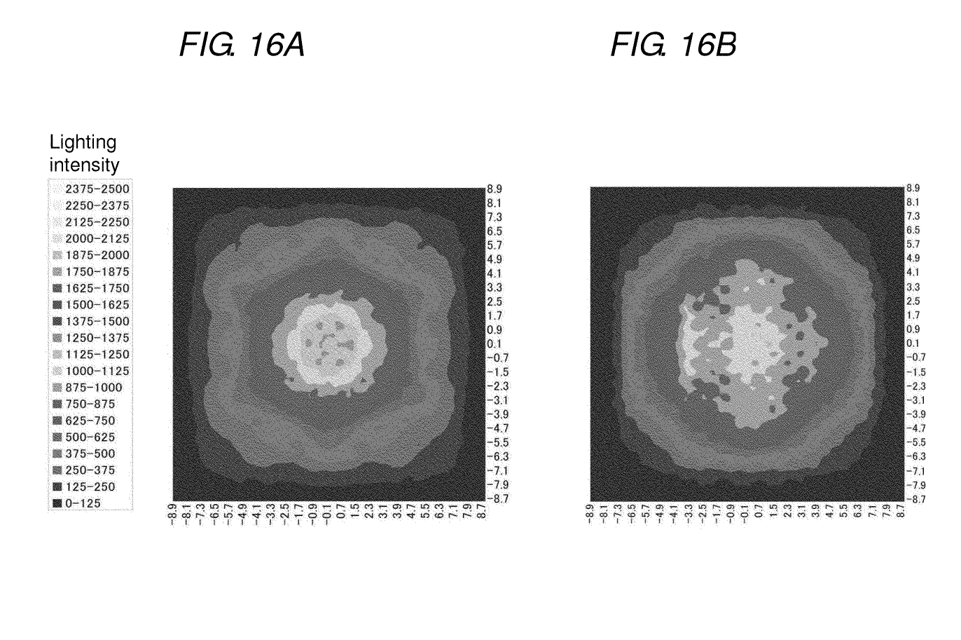

Luminance distribution on the keytop light-receiving surface 90 was analyzed for the columnar light guide 50. In the columnar light guide 50, the concave lens 52 in the incident surface had an inclination angle of 20 degrees, and the microlenses each having a diameter of 0.4 mm were arranged adjacent to each other to form the honeycomb structure in the outgoing surface. Other conditions were identical to those of Example 1. FIG. 16A illustrates a distribution diagram of the analysis result.

### EXAMPLE 3

The luminance distribution was analyzed for the square prism-shaped light guide 50 having a side of 3.2 mm. Other conditions were identical to those of Example 2. FIG. 16B illustrates a distribution diagram of the analysis result.

### Comparative Example 1

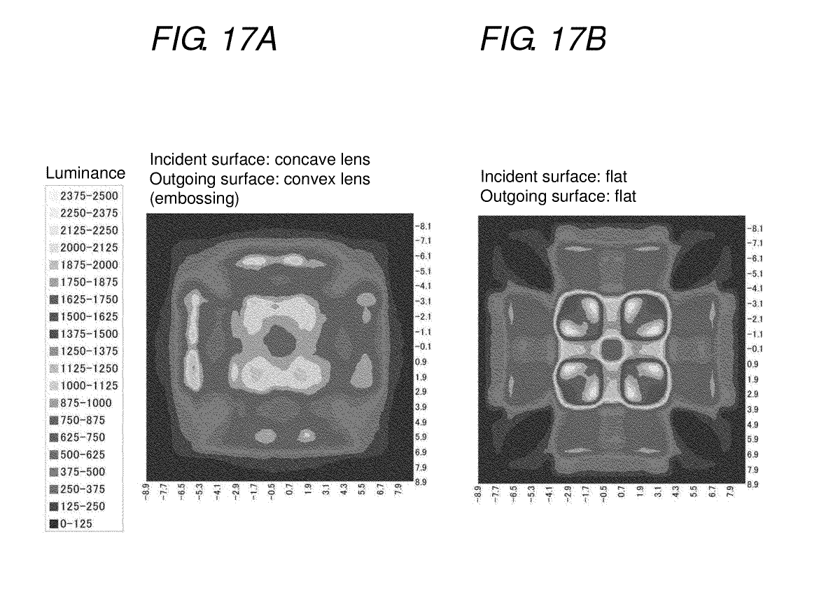

A concave lens 52 similar to that of Example 3 was formed in the incident surface, and the luminance distribution was analyzed. Other conditions were identical to those of Example 3 except that a convex lens was formed in the outgoing surface by embossing. FIG. 17A illustrates a distribution diagram of the analysis result.

### Comparative Example 2

The luminance distribution was analyzed under conditions identical to those of Example 3 except that the incident surface and the outgoing surface were formed into flat surfaces. FIG. 17B illustrates a distribution diagram of the analysis result.

When the distribution diagrams of Examples 2 and 3 are compared to the distribution diagrams of Comparative examples 1 and 2, it is found that the region having the good luminance uniformity in Examples 2 and 3 are wider than that in Comparative examples 1 and 2.

When the distribution diagrams of Examples 2 and 3 are compared to each other, it is found that the square prism-shaped light guide 50 is better than the columnar light guide 50 in the luminance uniformity.

### EXAMPLE 4

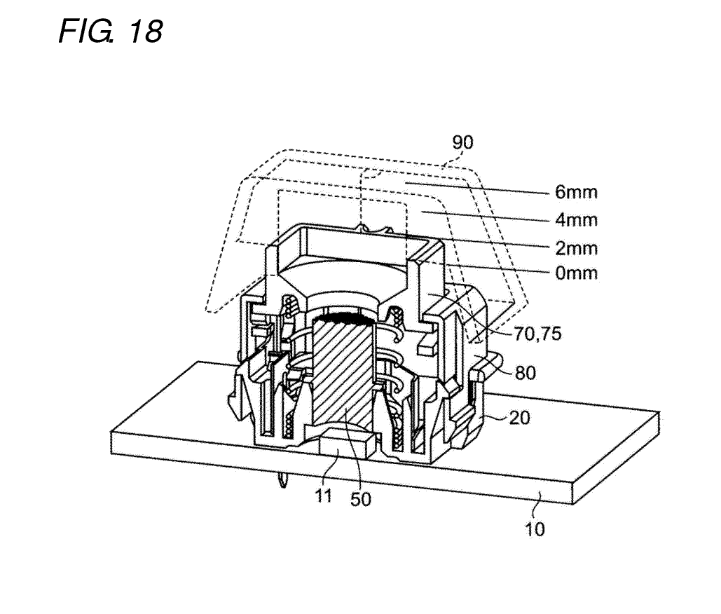

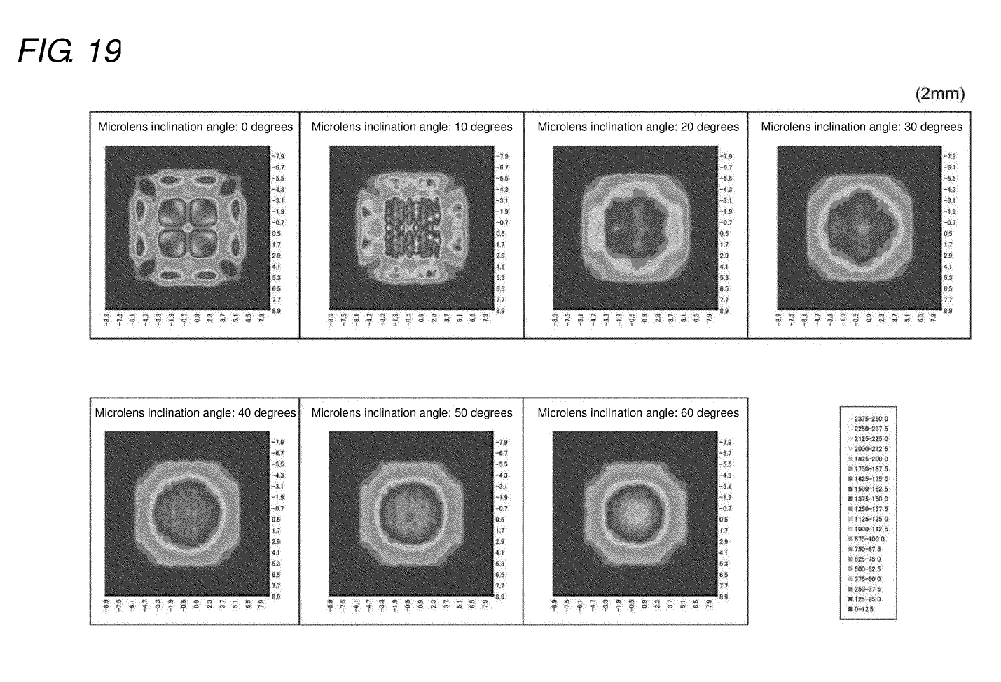

As illustrated in FIG. 18, the columnar light guide 50 having a diameter of 3.2 mm and a length of 7.5 mm was analyzed in order to check the correlation between the microlens inclination angle and the distance from the push button 70 provided with the columnar light guide 50 to the keytop. In the columnar light guide 50, the microlenses each having a diameter of 0.4 mm were arranged adjacent to each other to form the honeycomb structure in the outgoing surface. Particularly, as illustrated in FIG. 18, the luminance distribution was analyzed in a manner that, based on the opening edge 79 (distance of 0 mm) before the push-down of the push button 70, the microlens inclination angle was changed for each distance of 2 mm, 4 mm, or 6 mm from the opening edge 79 to the keytop. FIGS. 19, 20, and 21 illustrate distribution diagrams of the analysis results.

When the distribution diagrams in FIGS. 19, 20, and 21 are compared to one another, the distribution diagrams show that a light mixing effect is sufficient at a microlens inclination angle of greater than or equal to 20 degrees, and the luminance uniformity is determined to be good. Therefore, preferably the microlens inclination angle is greater than or equal to 20 degrees. Particularly, it is found that the light mixing effect and the luminance uniformity effect are not changed even if the distance to the keytop changes.

From the viewpoint of being able to light a wider region with increasing distance to the keytop, it is found that preferably the keytop lighting surface 90 is arranged at a height of at least 2 mm from the opening edge 79 of the push button 70 that is not pushed down.

An advantage of the switch according to an embodiment is that the switch may have the good luminance uniformity. Advantageously, a keyboard including the switch having the uniform luminance of the light output from the light guide and the wide, uniform luminance region is obtained. The switch of the present invention can be applied to not only the keyboard switch but also other switches which may be illuminated in use.

What is claimed is:

1. A switch comprising:
a light guide, wherein light emitted from a light source is output through an outgoing surface located in an upper end surface of the light guide, the light being incident from an incident surface located in a lower end surface of the light guide arranged above the light source, and
a concave lens is formed in the incident surface of the light guide, and a microlens array structure is formed into the outgoing surface of the light guide.

2. The switch according to claim 1, wherein the light source is directly mounted on a board.

3. The switch according to claim 1, wherein the light guide has a columnar shape.

4. The switch according to claim 2, wherein the light guide has a columnar shape.

5. The switch according to claim 1, wherein the light guide has a polygonal prism shape.

6. The switch according to claim 2, wherein the light guide has a polygonal prism shape.

7. The switch according to claim 1, wherein an inclination angle of the concave lens is less than or equal to 55 degrees.

8. The switch according to claim 1, wherein microlenses adjacent to each other are arranged into a lattice shape in the microlens array structure.

9. The switch according to claim 1, wherein microlenses adjacent to each other are arranged into a honeycomb structure in the microlens array structure.

10. The switch according to claim 1, wherein outer circumferential edges of the microlenses are overlapped with each other to form the microlens array structure.

11. The switch according to claim 1, wherein the microlens has a diameter of 1 mm or smaller.

12. The switch according to claim 1, wherein the inclination angle of the microlens ranges from 20 degrees to 60 degrees.

13. A keyboard comprising the switch according to claim 1.

14. A keyboard comprising:
a switch having a light guide, wherein light emitted from a light source is output through an outgoing surface located in an upper end surface of the light guide, the light being incident from an incident surface located in a lower end surface of the light guide arranged above the light source, and
a concave lens is formed in the incident surface of the light guide, and the outgoing surface is formed into a microlens array structure; and
a keytop, wherein light output from the concave lens through the outgoing surface passes through a lighting surface of the keytop.

15. The keyboard according to claim 14, wherein the switch comprises a push button having an opening edge, wherein the lighting surface of the keytop is arranged at a height of at least 2 mm from the opening edge of the push button when the push button is not pressed.

16. The keyboard according to claim 14, wherein the light guide has a polygonal prism shape.

17. The keyboard according to claim 14, wherein an inclination angle of the concave lens is less than or equal to 55 degrees.

18. The keyboard according to claim 14, wherein microlenses adjacent to each other are arranged into a honeycomb structure in the microlens array structure.

19. The keyboard according to claim 14, wherein the microlens has a diameter of 1 mm or smaller.

20. The keyboard according to claim 14, wherein the inclination angle of the microlens ranges from 20 degrees to 60 degrees.
